(19) United States
(12) Patent Application Publication
(10) Pub. No.: US 2025/0144835 A1
(43) Pub. Date: May 8, 2025

(54) FOOD CUTTER

(71) Applicant: Dongguan Geek Manufacturing Technology Co., Ltd., Dongguan (CN)

(72) Inventor: Lingli LI, Dongguan (CN)

(73) Assignee: Dongguan Geek Manufacturing Technology Co., Ltd., Dongguan (CN)

(21) Appl. No.: 19/016,273

(22) Filed: Jan. 10, 2025

(30) Foreign Application Priority Data
Jan. 3, 2025 (CN) 202520015489.3

(51) Int. Cl. B26D 7/18; B26D 3/18; B26D 5/10

(52) U.S. Cl. CPC B26D 7/1818; B26D 3/185; B26D 5/10; B26D 2210/02

(57) ABSTRACT

A food cutter includes a fixing seat, a blade and a movable contact member. The blade is mounted on the fixing seat, the movable contact member is movably mounted on the fixing seat along the cutting direction of the blade. The movable contact member is provided with a position-avoiding groove corresponding to a position of the blade, and the movable contact member is used to push and separate the cut food from the blade; the food cutter provided in the application significantly improves the efficiency and cleanliness of food cutting through an innovative structure integrating a fixing seat, a blade and a movable contact member; the blade is fixedly mounted on the fixing seat, ensuring the stability and accuracy of the cutting process; the design of the movable contact member allows its flexible movement in the cutting direction of the blade.

### CROSS-REFERENCE TO RELATED APPLICATIONS

This application claims priority to Chinese Patent Application No. 202520015489.3, filed on Jan. 3, 2025, the content of which is incorporated herein by reference in its entirety.

### TECHNICAL FIELD

The application relates to the technical field of kitchenware, and more particularly to a food cutter.

### BACKGROUND

Food cutting is a common kitchen activity in everyday life. When the conventional cutter cuts foods, especially wet soft or sticky food, food pieces or debris easily stick to the blade, resulting in reduced cutting efficiency and difficulty in cleaning. This not only affects the cutting quality of the food but also increases the labor intensity of the user.

### SUMMARY

The technical problem to be solved by the application is: a food cutter is provided to reduce sticking of food pieces or debris to the blade during cutting.

In order to solve the above-mentioned technical problem, the technical solution adopted by the application is: a food cutter, including a fixing seat, a blade mounted to the fixing seat, and a movable contact member movably mounted to the fixing seat in a cutting direction of the blade, wherein the movable contact member is provided with a position-avoiding groove corresponding to a position of the blade, and the movable contact member is used to push and separate the cut food from the blade.

Further, the fixing seat is provided with a fixing groove, the blade is mounted in the fixing groove, and the movable contact member is slidably mounted in the fixing groove.

Further, the blade is detachably mounted to the fixing groove.

Further, a packing member is also included and mounted at an edge of the fixing groove and connected with the blade.

Further, the blade is grid-shaped.

Further, the fixing seat is provided with a pressing handle.

Further, a quantity of the pressing handles is two, and the two pressing handles are provided on opposite sides of the fixing seat, respectively.

Further, the pressing handle and the fixing seat are of an integrated structure which is integrally formed.

Further, a side wall of the movable contact member is provided with an indicator, and the fixing seat is shielded from the indicator when the food to be cut is completely separated from the blade.

Further, the material of the indicator is a reflective material.

The beneficial effects of the application are: the food cutter provided by the application significantly improves the efficiency and cleanliness of food cutting by the innovative structure of the integrated fixing seat, blade and movable contact member. The fixed mounting of the blade to the fixing seat ensures the stability and accuracy of the cutting process. The design of the movable contact member allows its flexible movement in the cutting direction of the blade, which not only responds to the cutting needs of different foods, but also reduces the sticking of food debris to the blade during the cutting process by means of a clever arrangement of the position-avoiding groove. Of particular importance is that the pushing function of the movable contact member enables the cut food to be quickly separated from the blade, an automated process that greatly reduces manual intervention, reduces operational complexity, and improves post-cutting cleaning efficiency. In addition, this design also helps to extend the service life of the blade as blade damage due to sticking is reduced. Overall, the food cutter provides the user with an efficient, hygienic, easy to operate and maintain cutting solution.

### BRIEF DESCRIPTION OF THE DRAWINGS

FIG. 1 is an assembly view of a food cutter according to Example 1 of the application.

FIG. 2 is an exploded view of the food cutter according to Example 1 of the application.

### DETAILED DESCRIPTION OF THE EMBODIMENTS

In order to explain the technical contents, the objects, and the effects of the application in detail, the embodiments will be described below with reference to the accompanying drawings.

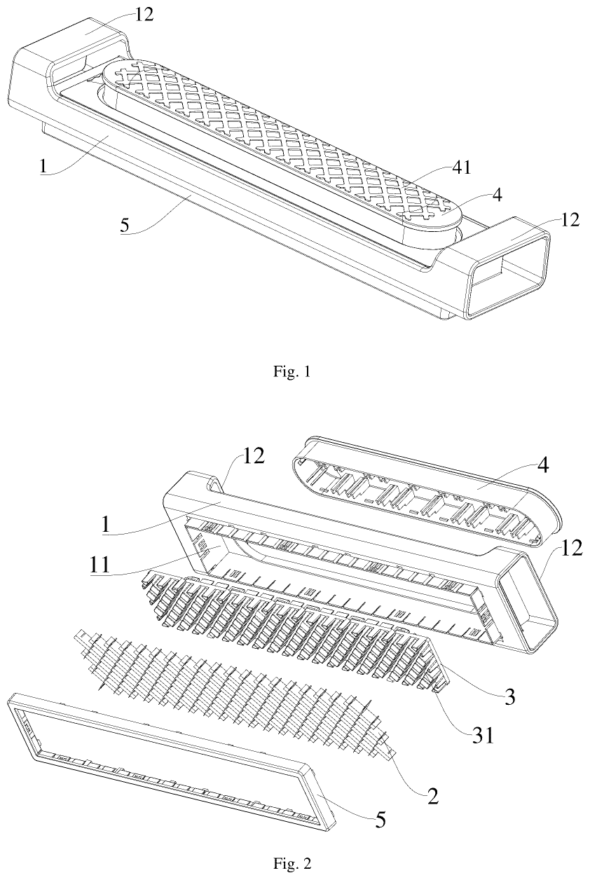

Referring to FIGS. 1 and 2, a food cutter includes a fixing seat 1, a blade 2 mounted to the fixing seat 1, and a movable contact member 3 movably mounted to the fixing seat 1 in a cutting direction of the blade 2, wherein the movable contact member 3 is provided with a position-avoiding groove 31 corresponding to a position of the blade 2, the movable contact member 3 is used to push and separate the cut food from the blade 2.

As can be seen from the above description, the beneficial effects of the application are as follows: by integrating the innovative structure of the fixing seat 1, the blade 2 and the movable contact member 3, the efficiency and cleanliness of food cutting is significantly improved. The fixed mounting of the blade 2 to the fixing seat 1 ensures the stability and accuracy of the cutting process. The design of the movable contact member 3 allows its flexible movement in the cutting direction of the blade 2, which not only responds to the cutting needs of different foods, but also reduces the sticking of food debris to the blade 2 during the cutting process by means of a clever arrangement of the position-avoiding groove 31. It is particularly important that the pushing function of the movable contact member 3 enables the cut food to be quickly separated from the blade 2, an automated process which greatly reduces manual intervention, reduces operational complexity and at the same time improves the cleaning efficiency after cutting. Furthermore, this design also helps to extend the service life of the blade 2, as damage to the blade 2 due to sticking is reduced.

Further, the fixing seat 1 is provided with a fixing groove 11, the blade 2 is mounted in the fixing groove 11, and the movable contact member 3 is slidably mounted in the fixing groove 11.

As can be seen from the above description, the fixing groove 11 provided in the fixing seat 1 provides a stable mounting platform for the blade 2 and the movable contact member 3. The slidably mounting of the blade 2 and the movable contact member 3 increases the flexibility and adaptability of the cutter, making the cutting process smoother.

Further, the blade 2 is detachably mounted to the fixing groove 11.

As can be seen from the above description, the detachable design of the blade 2 allows the user to quickly replace the blade 2 according to different cutting requirements, improving the versatility of the cutter and the convenience of maintenance.

Further, a packing member 5 is also included and mounted at an edge of the fixing groove 11 and connected with the blade 2.

As can be seen from the above description, the addition of the packing member 5 enhances the safety of the cutter, preventing the blade 2 from accidentally injuring the user during operation, while the connection of the packing member 5 to the blade 2 also helps to maintain the stability of the blade 2 during use.

Further, the blade 2 is grid-shaped.

As can be seen from the above description, the grid-shaped design of the blade 2 allows a plurality of small grid-shaped food to be cut at one time, which is particularly suitable for applications requiring rapid and uniform cutting of large amounts of food, such as salad making or cooking preparation.

Further, the fixing seat 1 is provided with a pressing handle 12.

As can be seen from the above description, the pressing handle 12 on the fixing seat 1 provides an ergonomic operation method by which the user can easily control the cutting action of the blade 2, which improves the comfort and safety of operation.

Further, a quantity of the pressing handles 12 is two, and two pressing handles 12 are provided on opposite sides of the fixing seat 1, respectively.

As can be seen from the above description, in the design, two pressing handles 12 are respectively provided on two opposite sides of the fixing seat 1, and this symmetrical design provides better balance and operation stability, especially when a greater force is required to press and cut, and a user can operate with both hands to improve the cutting efficiency and stability.

Further, a side wall of the movable contact member 3 is provided with an indicator, and the fixing seat 1 is shielded from the indicator when the food to be cut is completely separated from the blade 2.

As can be seen from the above description, the indicators on the side wall of the movable contact member 3 provide the user with an intuitive visual feedback, so that the user can clearly know whether the food has completely separated from the blade 2, and such a design improves the accuracy and convenience of operation.

Furthermore, the material of the indicator is a reflective material.

As can be seen from the above description, the indicator is made of a reflective material and can be clearly seen in a dark environment, and such a design improves the usability of the cutter in various environments and enhances the safety.

Referring to FIGS. 1 and 2, Example 1 of the application is: a food cutter for cutting food; the food cutter includes a fixing seat 1, a blade 2 and a movable contact member 3, wherein the blade 2 is mounted on the fixing seat 1, the movable contact member 3 is movably mounted on the fixing seat 1 along the cutting direction of the blade 2, the movable contact member 3 is provided with a position-avoiding groove 31 corresponding to the position of the blade 2, and the movable contact member 3 is used to push and separate the cut food from the blade 2; specifically, in the actual use process, the user holds the fixing seat 1 and aligns the blade 2 with the food to be cut, then presses the fixing seat 1 so that the blade 2 cuts the food, and then pushes the movable contact member 3 to contact the cut food so that the food is separated from the surface of the blade 2; more specifically, the food cutter further includes a pressing member 4, wherein the pressing member 4 is exposed on a side of the fixing seat 1 facing away from the blade 2 and is connected to the movable contact member 3, and the movable contact member 3 can be moved in a direction close to the blade 2 by pressing the pressing member 4, thereby pushing the cut food; in detail, the top of the pressing member 4 is further provided with an anti-slip groove 41 for user's convenience.

Preferably, the fixing seat 1 is provided with a fixing groove 11, the blade 2 is mounted in the fixing groove 11, and the movable contact member 3 is slidably mounted in the fixing groove 11, and it can be understood that the fixing groove 11 provided in the fixing seat 1 provides a stable mounting platform for the blade 2 and the movable contact member 3. The slidably mounting of the blade 2 and the movable contact member 3 increases the flexibility and adaptability of the cutter, making the cutting process smoother; specifically, the blade 2 is detachably mounted on the fixing groove 11, and the detachable design of the blade 2 enables a user to quickly replace the blade 2 according to different cutting requirements, thereby improving the versatility of the cutter and the convenience of maintenance; more specifically, the food cutter further includes a packing member 5 detachably mounted at the edge of the fixing groove 11 and connected to the blade 2, the addition of the packing member 5 enhances the safety of the cutter and prevents the blade 2 from accidentally injuring the user during operation, while the connection of the packing member 5 to the blade 2 also helps to maintain the stability of the blade 2 during use. The detachable connection mode includes but is not limited to a bolt connection, a screw connection, a snap connection, a latch connection or a magnetic suction connection, and can be specifically set according to actual application requirements.

In the embodiment, the blade 2 is grid-shaped, the grid-shaped design of the blade 2 allowing a plurality of small grid-shaped food to be cut at one time, which is particularly suitable for applications requiring rapid and uniform cutting of large amounts of food, such as salad making or cooking preparation; further, the fixing seat 1 is provided with a pressing handle 12, the pressing handle 12 on the fixing seat 1 provides an ergonomic operation method, and a user can easily control the cutting action of the blade 2 by pressing the handle 12, and such a design improves the comfort and safety of operation; in particular, in the embodiment, the pressing handle 12 and the fixing seat 1 are of an integrated structure which is integrally formed, and a quantity of the pressing handles 12 is two, wherein two of the pressing handles 12 are respectively provided on two opposite sides of the fixing seat 1, and two pressing handles 12 are respectively provided on two opposite sides of the fixing seat 1 in the design, and this symmetrical design provides better balance and operation stability, especially when pressing and cutting with great strength, a user can operate with both hands to improve the cutting efficiency and stability.

As an alternative, the side wall of the movable contact member 3 may also be provided with an indicator (not shown), and the fixing seat 1 is shielded from the indicator when the food to be cut is completely separated from the blade 2; the indicator provides the user with an intuitive visual feedback, so that the user can clearly know whether the food has completely separated from the blade 2, and such a design improves the accuracy and convenience of operation; the material of the indicator may be a reflective material, which is clearly visible in a dark environment, and such a design improves the usability of the cutter in various environments and enhances the safety.

In summary, the food cutter provided by the application significantly improves the efficiency and cleanliness of food cutting by the innovative structure of the integrated fixing seat, blade and movable contact member. The fixed mounting of the blade to the fixing seat ensures the stability and accuracy of the cutting process. The design of the movable contact member allows its flexible movement in the cutting direction of the blade, which not only responds to the cutting needs of different foods, but also reduces the sticking of food debris to the blade during the cutting process by means of a clever arrangement of the position-avoiding groove. Of particular importance is that the pushing function of the movable contact member enables the cut food to be quickly separated from the blade, an automated process that greatly reduces manual intervention, reduces operational complexity, and improves post-cutting cleaning efficiency. In addition, this design also helps to extend the service life of the blade as blade damage due to sticking is reduced. Overall, the food cutter provides the user with an efficient, hygienic, easy to operate and maintain cutting solution.

The above-mentioned description is only an example of the application, and is not intended to limit the scope of the application, and all equivalent transformation performed by using the contents of the specification and the drawings of the application or directly or indirectly applied to the related technical fields are included in the scope of the application.

What is claimed is:

1. A food cutter, comprising a fixing seat, a blade mounted to the fixing seat, and a movable contact member movably mounted to the fixing seat in a cutting direction of the blade, wherein
the movable contact member is provided with a position-avoiding groove corresponding to a position of the blade, and the movable contact member is used to push and separate cut food from the blade.

2. The food cutter according to claim 1, wherein the fixing seat is provided with a fixing groove, the blade is mounted in the fixing groove, and the movable contact member is slidably mounted in the fixing groove.

3. The food cutter according to claim 2, wherein the blade is detachably mounted to the fixing groove.

4. The food cutter according to claim 3, further comprising a packing member mounted at an edge of the fixing groove and connected with the blade.

5. The food cutter according to claim 1, wherein the blade is grid-shaped.

6. The food cutter according to claim 1, wherein the fixing seat is provided with a pressing handle.

7. The food cutter according to claim 6, wherein a quantity of the pressing handles is two, and the two pressing handles are provided on opposite sides of the fixing seat, respectively.

8. The food cutter according to claim 7, wherein the pressing handle and the fixing seat are of an integrated structure which is integrally formed.

9. The food cutter according to claim 1, wherein a side wall of the movable contact member is provided with an indicator, and the fixing seat is shielded from the indicator when the food to be cut is completely separated from the blade.

10. The food cutter according to claim 9, wherein a material of the indicator is a reflective material.
